(19) United States
(12) Patent Application Publication
(10) Pub. No.: US 2018/0026864 A1
(43) Pub. Date: Jan. 25, 2018

(54) COMMUNICATION APPARATUS, COMMUNICATION SYSTEM, AND COMMUNICATION METHOD

(71) Applicant: NEC CORPORATION, Tokyo (JP)

(72) Inventor: Yu AOKI, Tokyo (JP)

(73) Assignee: NEC CORPORATION, Tokyo (JP)

(21) Appl. No.: 15/549,225

(22) PCT Filed: Jan. 15, 2016
(86) PCT No.: PCT/JP2016/000196

§ 371 Date: Aug. 7, 2017

(30) Foreign Application Priority Data
Feb. 19, 2015 (JP) 2015-030445

(51) Int. Cl. H04L 12/26; H04L 12/24

(52) U.S. Cl. CPC H04L 43/08; H04L 41/06

(57) ABSTRACT

A communication apparatus (100) includes a plurality of transmitting ports (101-1 to 101-3) constituting a link aggregation, and an input port (102-1). The communication apparatus (100) transmits a specific packet input from the input port (102-1) from a specific transmitting port among the plurality of transmitting ports (101-1 to 101-3), and transmits a first non-specific packet input from the input port (102-1) from a transmitting port other than the specific transmitting port among the plurality of transmitting ports (101-1 to 101-3), the first non-specific packet being a packet other than the specific packet and having a predetermined packet length or longer.

### TECHNICAL FIELD

The present disclosure relates to a communication apparatus, a communication system, and a communication method.

### BACKGROUND ART

In general, in a communication apparatus that transfers packets such as a switch and a router, a plurality of packets to be transmitted are temporarily stored in a buffer and then these packets are serially transmitted from a transmitting port. Therefore, when there is a packet that has already started to be transmitted from the transmitting port, transmission of the next packet starts after waiting for the completion of the transmission of the above packet. Therefore, there are cases in which even a specific packet that should be preferentially transmitted is put into a transmission waiting state in the buffer and hence the transmission delay is increased by an amount equivalent to that transmission waiting time. For example, a time necessary for outputting a long packet having a packet length of 9,600 bytes (i.e., a jumbo packet) from a transmitting port having a transmission rate of 1 Gbps is about 80 microseconds. Therefore, even for a specific packet, a transmission waiting time (=a transmission delay time) of about 80 microseconds could occur in a random manner. Further, the so-called delay variation (PDV: Packet Delay Variation) in which a transmission delay time changes from one packet to another because some packet is put in a transmission waiting state could occur. In recent years, a function of synchronizing a clock or a time by transmitting/receiving a predetermined packet between a master and a slave has been specified (e.g., IEEE (Institute of Electrical and Electronic Engineers) 1588). However, for this function, the above-described packet transmission delay and the delay variation could cause a serious problem.

The packet transmission delay and the delay variation are explained hereinafter with reference to FIG. 1. Referring to FIG. 1, in a communication apparatus 300, specific packets input from an input port 301-1 (packets indicated by a check pattern in the figure) are temporarily stored in a buffer 302 and then transmitted from a transmitting port 303-1. Further, packets other than the specific packets input from an input port 301-2 are temporarily stored in the buffer 302 and then transmitted from the transmitting port 303-1. Meanwhile, in a communication apparatus 400, specific packets received through a receiving port 401-1 are output from an output port 402-1 and packets other than the specific packets received through the receiving port 401-1 are output from an output port 402-2. Note that the specific packets are preferentially transmitted in the communication apparatus 300. However, when a packet other than the specific packet has already started to be transmitted from the transmitting port 303-1, the specific packet is put in a transmission waiting state and kept in the buffer 302 until the transmission of the other packet is completed. Here, a difference between a timing at which the specific packet is input from the input port 301-1 and a timing at which that specific packet is output from the output port 402-1 is defined as a transmission delay time. The transmission delay time of specific packets Y1 to Y4 that were not put in a transmission waiting state is a transmission delay time having a fixed length of time. In contrast to this, a specific packet X that was put in a transmission waiting state has a transmission delay time that is longer than the transmission delay time of the specific packets Y1 to Y4 by an amount equivalent to the duration of the transmission waiting state. As a result, a delay variation for the specific packets occurs.

Incidentally, in recent years, in ITU-T (International Telecommunication Union-Telecommunication Standardization Sector) 802.1AX, a technique called a Link Aggregation (LAG) in which a plurality of physical links are virtually bundled and used as one logical link has been standardized. To implement the LAG, a plurality of transmitting ports constituting the LAG are provided in a communication apparatus on a transmitting side and packets to be transmitted that have been temporarily stored in a buffer are distributed to any of the plurality of transmitting ports. In the case of the LAG, packets are serially transmitted from each of the plurality of transmitting ports. Therefore, when a packet having a long packet length is distributed to a transmitting port to which a specific packet is also distributed, a transmission delay and/or a delay variation for the specific packet could occur.

Patent Literature 1 discloses an example technique related to the packet distribution in the LAG. In the technique disclosed in Patent Literature 1, packets to be transmitted are divided into high-priority packets and low-priority packets, and the high-priority packets are preferentially transmitted. Further, in the technique disclosed in Patent Literature 1, when a radio transmission link to which a high-priority packet is distributed is selected, the radio transmission link is selected by applying a hush function to a value of a header of the high-priority packet. Alternatively, a radio transmission link having the best condition (e.g., a radio transmission link having the highest reception level) is selected.

### CITATION LIST

### Patent Literature

Patent Literature 1: International Patent Publication No. WO2013/111772

### SUMMARY OF INVENTION

### Technical Problem

However, the technique disclosed in Patent Literature 1 cannot eliminate a possibility that a low-priority packet may be distributed to a radio transmission link to which a high-priority packet has already been distributed. It should be noted that in the technique disclosed in Patent Literature 1, a low-priority packet is divided into cells (i.e., packets having a fixed length) and then transmitted. Therefore, even if a low-priority packet is distributed to a radio transmission link to which a high-priority packet has already been distributed, the low-priority packet has the fixed packet length, i.e., a short packet length. Therefore, it is considered that even if the high-priority packet is put in a transmission waiting state for waiting for the transmission of the low-priority packet, the duration of this transmission waiting state is not long.

However, in the technique disclosed in Patent Literature 1, it is necessary to uniformly divide low-priority packets into cells. This cell dividing process includes not only simply dividing a low-priority packet into cells, but also temporarily storing each cell into a buffer and assigning a sequence number to each cell. Therefore, the processing load of this cell dividing process is very large.

Accordingly, one of the objects of the present disclosure is to provide a communication apparatus, a communication system, and a communication method capable of solving the above-described problem and reducing a transmission delay and a delay variation for specific packets without dividing other packets.

### Solution to Problem

In an aspect, a communication apparatus includes a plurality of transmitting ports constituting a link aggregation, and an input port. The communication apparatus transmits a specific packet input from the input port from a specific transmitting port among the plurality of transmitting ports, and transmits a first non-specific packet input from the input port from a transmitting port other than the specific transmitting port among the plurality of transmitting ports, the first non-specific packet being a packet other than the specific packet and having a predetermined packet length or longer.

In an aspect, a communication system includes first and second communication apparatuses connected to each other by a link aggregation. The first communication apparatus includes a plurality of transmitting ports constituting a link aggregation, and an input port. The second communication apparatus includes a plurality of receiving ports constituting a link aggregation. The first communication apparatus transmits a specific packet input from the input port from a specific transmitting port among the plurality of transmitting ports, and transmits a first non-specific packet input from the input port from a transmitting port other than the specific transmitting port among the plurality of transmitting ports, the first non-specific packet being a packet other than the specific packet and having a predetermined packet length or longer.

In an aspect, a communication method is a communication method performed by a communication apparatus. The communication apparatus includes a plurality of transmitting ports constituting a link aggregation, and an input port. The communication method includes transmitting a specific packet input from the input port from a specific transmitting port among the plurality of transmitting ports, and transmitting a first non-specific packet input from the input port from a transmitting port other than the specific transmitting port among the plurality of transmitting ports, the first non-specific packet being a packet other than the specific packet and having a predetermined packet length or longer.

In another aspect, a communication method is a communication method performed by a communication system including first and second communication apparatuses connected to each other by a link aggregation. The first communication apparatus includes a plurality of transmitting ports constituting a link aggregation, and an input port, and the second communication apparatus includes a plurality of receiving ports constituting a link aggregation. The communication method includes transmitting, by the first communication apparatus, a specific packet input from the input port from a specific transmitting port among the plurality of transmitting ports, and transmitting, by the first communication apparatus, a first non-specific packet input from the input port from a transmitting port other than the specific transmitting port among the plurality of transmitting ports, the first non-specific packet being a packet other than the specific packet and having a predetermined packet length or longer.

### Advantageous Effects of Invention

According to the above-described aspect, it is possible to achieve an advantageous effect that a transmission delay and a delay variation for specific packets can be reduced without dividing other packets.

### BRIEF DESCRIPTION OF DRAWINGS

FIG. 1 is a diagram for showing a transmission delay and a delay variation of packets;

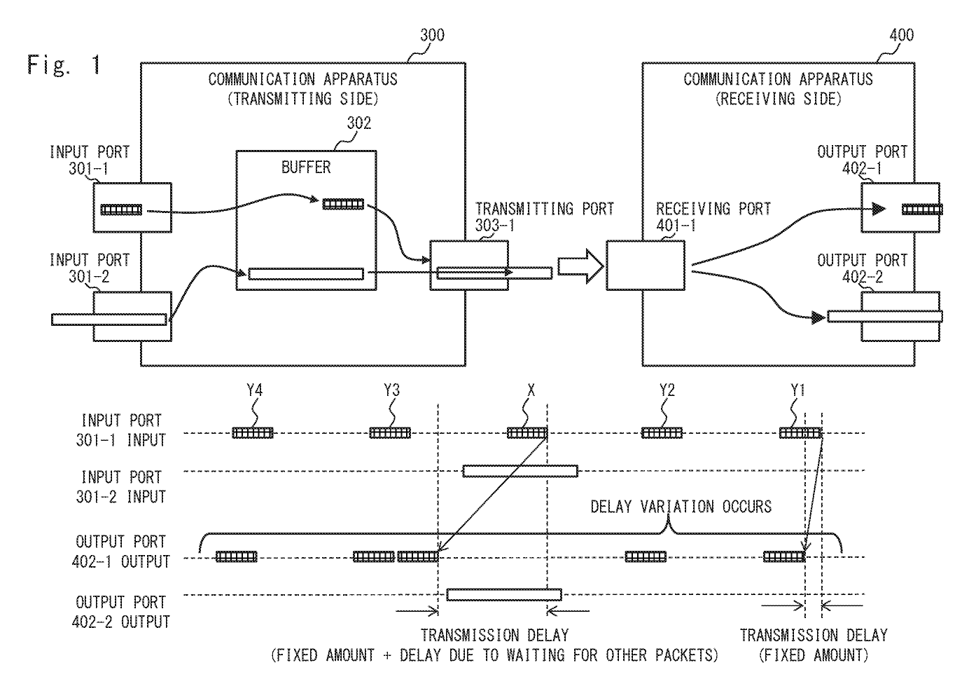

FIG. 2 shows a configuration example of a communication system according to a first embodiment;

FIG. 3 shows a configuration example of a communication system according to a second embodiment;

FIG. 4 is a flowchart showing an operation example of a communication apparatus 100 according to the second embodiment;

FIG. 5 shows a configuration example of a communication system according to a third embodiment; and

FIG. 6 shows a configuration example of a communication system according to a fourth embodiment.

### DESCRIPTION OF EMBODIMENTS

Embodiments according to the present disclosure are explained hereinafter with reference to the drawings.

### (1) First Embodiment

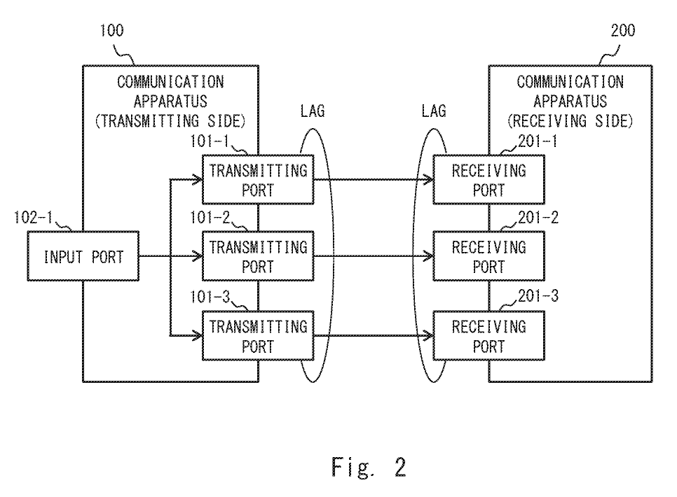

FIG. 2 shows a configuration example of a communication system according to this embodiment. The communication system shown in FIG. 2 includes a communication apparatus 100 (a first communication apparatus) and a communication apparatus 200 (a second communication apparatus) connected to each other by an LAG, and has a configuration in which packets are transmitted from the communication apparatus 100 to the communication apparatus 200. The communication apparatus 100 on the transmitting side includes three transmitting ports 101-1 to 101-3 constituting an LAG, and an input port 102-1. The input port 102-1 is a physical port from which packets to be transmitted are input. The transmitting ports 101-1 to 101-3 are physical ports from which the packets input from the input port 102-1 are transmitted to the communication apparatus 200, which is an apparatus on the other side, through corresponding physical links. Meanwhile, the communication apparatus 200 on the receiving side includes three receiving ports 201-1 to 201-3 constituting an LAG. The receiving ports 201-1 to 201-3 are physical ports from which the packets transmitted from the communication apparatus 100, which is the apparatus on the other side, are received through corresponding physical links. Note that the number of ports constituting an LAG is not limited to three. That is, the number of ports may be any number no less than two.

In this embodiment, the communication apparatus 100 transmits specific packets input from the input port 102-1 from a specific transmitting port among the transmitting ports 101-1 to 101-3. The specific packet is a packet that is defined in advance as a packet that should be preferentially transmitted. Examples of the specific packet include a packet that is transmitted/received in order to synchronize a clock or a time between a master and a slave specified in IEEE1588, and a packet having a high priority in QoS (Quality of Service) control. Further, the communication apparatus 100 transmits packets other than the specific packets (first non-specific packets) that are input from the input port 102-1 and have a predetermined packet length or longer from a transmitting port other than the specific transmitting port among the transmitting ports 101-1 to 101-3. For example, when the transmitting port 101-3 is defined as a specific transmitting port, the communication apparatus 100 transmits specific packets from the transmitting port 101-3 and transmits packets that are other than the specific packets and have the predetermined packet length or longer from the transmitting port 101-1 or 101-2, i.e., from a transmitting port other than the transmitting port 101-3.

As described above, in this embodiment, the communication apparatus 100 transmits specific packets from a specific transmitting port and transmits packets that are other than the specific packets and have the predetermined packet length or longer from a transmitting port other than the specific transmitting port. Therefore, since no packet that is not a specific packet and has a long packet length is transmitted from the specific transmitting port from which a specific packet is transmitted, a transmission waiting time for the specific packet is reduced. As a result, it is possible to achieve an advantageous effect that a transmission delay and a delay variation for specific packets can be reduced without dividing other packets that are not specific packets.

### (2) Second Embodiment

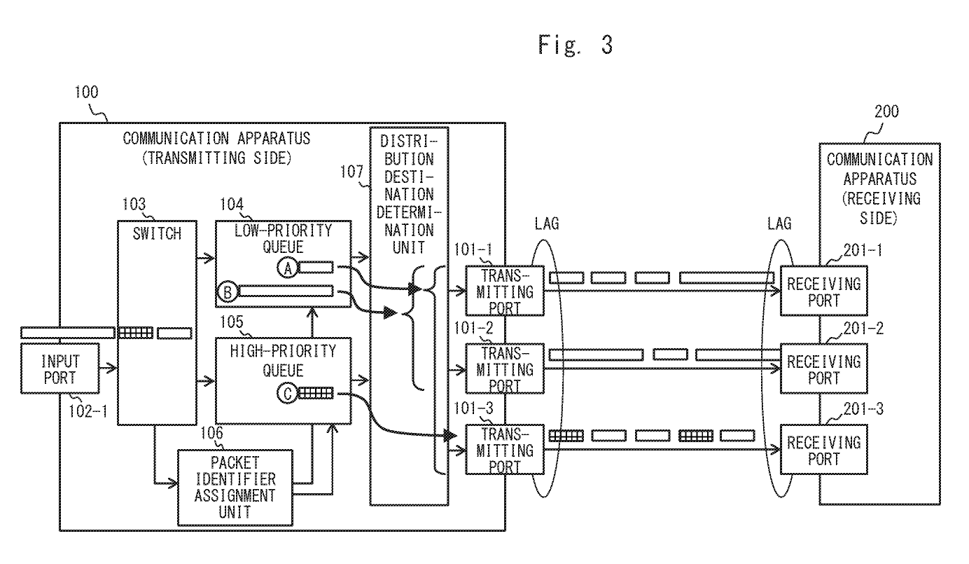

In this embodiment, a configuration and an operation of the communication apparatus 100 according to the first embodiment are described in a more concrete manner. FIG. 3 shows a configuration example of a communication system according to this embodiment. The configuration of a communication apparatus 100 in the communication system shown in FIG. 3 differs from that in the first embodiment shown in FIG. 2. The communication apparatus 100 includes transmitting ports 101-1 to 101-3, an input port 102-1, a switch 103, a low-priority queue 104, a high-priority queue 105, a packet identifier assignment unit 106, and a distribution destination determination unit 107. Note that although FIG. 3 shows the communication apparatus 100 including one input port 102-1 and three transmitting ports 101-1 to 101-3, the communication apparatus 100 may include other input ports and other transmitting ports. Further, although FIG. 3 shows a communication apparatus 200 including three receiving ports 201-1 to 201-3, the communication apparatus 200 may include other receiving ports and output ports. That is, the only requirement for this embodiment is that the number of ports constituting an LAG in one of the apparatuses connected to each other by the LAG should be equal to the number of ports constituting the LAG in the other apparatus. That is, the number of ports that are not included in the LAG is not limited to any number.

Packets to be transmitted are input from the input port 102-1.

The switch 103 determines a transmitting port from which a packet to be transmitted input from the input port 102-1 is transmitted based on a destination of that packet to be transmitted. However, when a packet to be transmitted is transmitted to the communication apparatus 200, the switch 103 determines only that the packet should be transmitted from a port included in the LAG constituted by the transmitting ports 101-1 to 101-3. That is, as described later, the final determination as to which of the transmitting ports 101-1 to 101-3 becomes the distribution destination is made by the distribution destination determination unit 107. Further, the switch 103 temporarily stores the packet to be transmitted in either a high-priority queue or a low-priority queue provided between the aforementioned determined transmitting port and the switch 103 depending on whether the packet to be transmitted is a specific packet (a packet indicated by a check pattern in the figure) or not. For example, in the case where the switch 103 determines that the packet to be transmitted should be transmitted from the transmitting ports 101-1 to 101-3 constituting the LAG, when the packet to be transmitted is a specific packet, the switch 103 temporarily stores the packet to be transmitted in the high-priority queue 105. On the other hand, when the packet to be transmitted is a packet other than the specific packet, the switch 103 temporarily stores the packet to be transmitted in the low-priority queue 104. Note that in the case where the switch 103 determines that the packet should be transmitted from a transmitting port that is not shown in the figure, the switch 103 stores the packet in either a low-priority queue or a high-priority queue provided between that transmitting port and the switch 103 that are not shown in the figure.

The low-priority queue 104 is a queue in which packets other than specific packets are temporarily stored, while the high-priority queue 105 is a queue in which the specific packets are temporarily stored. Note that the low-priority queue 104 and the high-priority queue 105 are disposed in a buffer that is not shown in the figure.

The packet identifier assignment unit 106 assigns identifiers to packets to be transmitted stored in the low-priority and high-priority queues 104 and 105 according to whether they are specific packets or not. Further, when the packets to be transmitted are packets other than the specific packets, the packet identifier assignment unit 106 assigns identifiers according to whether or not they have a predetermined packet length or longer. Specifically, for a packet to be transmitted, the packet identifier assignment unit 106 assigns an identifier C when that packet is a specific packet, assigns an identifier B when that packet is a packet other than the specific packet and has a predetermined packet length or longer (a first non-specific packet), and assigns an identifier A when that packet is a packet other than the specific packet and has a packet length shorter than the predetermined packet length (a second non-specific packet). In the figure, an identifier is shown to the left of each packet.

The distribution destination determination unit 107 determines distribution destination transmitting ports for the packets to be transmitted stored in the low-priority and high-priority queues 104 and 105 based on the identifiers assigned to these packets to be transmitted, and distributes the packets to be transmitted to the determined distribution destination transmitting ports. Specifically, a specific transmitting port among the transmitting ports 101-1 to 101-3 is determined as the distribution destination of the packet to which the identifier C is assigned. At least one transmitting port should be determined as the specific transmitting port. Further, one of the transmitting ports 101-1 to 101-3 other than the specific transmitting port is determined as the distribution destination of the packet to which the identifier B is assigned. Further, one of the transmitting ports 101-1 to 101-3 is determined as the distribution destination of the packet to which the identifier A is assigned. In this embodiment, it is assumed that the transmitting port 101-3 is defined as the specific transmitting port. Therefore, the transmitting port 101-3 is determined as the distribution destination of the packet to which the identifier C is assigned, and either of the transmitting ports 101-1 and 101-2, i.e., a transmitting port other than the transmitting port 101-3 is randomly determined as the distribution destination of the packet to which the identifier B is assigned. Further, one of the transmitting ports 101-1 to 101-3 is randomly determined as the distribution destination of the packet to which the identifier A is assigned. Note that when the distribution destination of the packet to which the identifier B or C is assigned is randomly determined, it is possible to determine the distribution destination by, for example, performing hash calculation by using a value of a MAC header of that packet and determining the distribution destination based on the obtained hash value.

The transmitting ports 101-1 to 101-3 transmit the packets, which have been distributed to these ports, to the communication apparatus 200, which is an apparatus on the other side, through physical links corresponding to these ports.

The receiving ports 201-1 to 201-3 receive the packets from the communication apparatus 100, which is the apparatus on the other side, through physical links corresponding to these ports.

Note that when the communication apparatus 200 receives the packets through the receiving ports 201-1 to 201-3, the communication apparatus operates so as to output these packets from a transmitting port that is not shown in the figure based on the destinations of these packets. However, this operation is the same as the existing operation performed by an existing communication apparatus equipped with an LAG function and therefore its explanation is omitted.

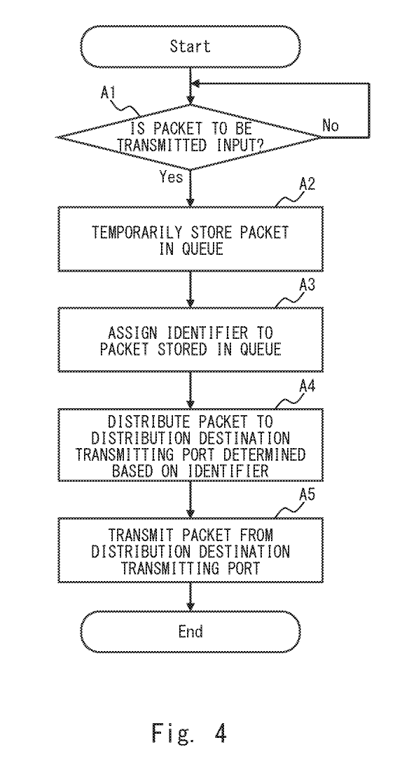

An example of an operation performed by the communication apparatus 100 according to this embodiment is explained hereinafter with reference to FIG. 4. Referring to FIG. 4, when a packet to be transmitted is input from the input port 102-1 (Yes at step A1), the switch 103 determines a transmitting port for the packet to be transmitted based on the destination of the packet to be transmitted. Further, the switch 103 temporarily stores the packet to be transmitted in either a high-priority queue or a low-priority queue provided between the aforementioned determined transmitting port and the switch 103 depending on whether the packet to be transmitted is a specific packet or not (step A2). In this example, it is assumed that the switch 103 has determined the transmitting ports 101-1 to 101-3 constituting an LAG as the transmitting port, temporarily stored packets to be transmitted that are specific packets in the high-priority queue 105, and temporarily stored packets to be transmitted that are not the specific packets in the low-priority queue 104. Next, for the packets to be transmitted stored in the low-priority and high-priority queues 104 and 105, the packet identifier assignment unit 106 assigns an identifier C to the specific packets, assigns an identifier B to packets that are other than the specific packets and have a predetermined packet length or longer, and assigns an identifier A to packets that are other than the specific packets and have a packet length shorter than the predetermined packet length (step A3). Next, the distribution destination determination unit 107 determines distribution destination transmitting ports for the packets to be transmitted stored in the low-priority and high-priority queues 104 and 105 based on the identifiers assigned to these packets to be transmitted, and distributes these packets to be transmitted to the determined distribution destination transmitting ports (step A4). In this embodiment, it is assumed that the transmitting port 101-3 is defined as the specific transmitting port. Therefore, the distribution destination determination unit 107 determines the transmitting port 101-3 as the distribution destination of the packets to which the identifier C is assigned, randomly determines either of the transmitting ports 101-1 and 101-2, i.e., a transmitting port other than the transmitting port 101-3 as the distribution destination of the packets to which the identifier B is assigned, and randomly determines one of the transmitting ports 101-1 to 101-3 as the distribution destination of the packets to which the identifier A is assigned. After that, the packets to be transmitted are transmitted from the transmitting ports, to which they have been distributed by the distribution destination determination unit 107, to the communication apparatus 200, which is an apparatus on the other side, through physical links corresponding to these transmitting ports (step A5).

As described above, in this embodiment, the communication apparatus 100 assigns an identifier C to specific packets and transmits them from a specific transmitting port. Further, the communication apparatus 100 assigns an identifier B to packets that are packets other than the specific packet and have the predetermined packet length or longer and transmits them from a transmitting port other than the specific transmitting port. Therefore, since no packet that is not a specific packet and has a long packet length is transmitted from the specific transmitting port from which a specific packet is transmitted, a transmission waiting time for the specific packet is reduced. As a result, it is possible to achieve an advantageous effect that a transmission delay and a delay variation for specific packets can be reduced without dividing other packets that are not specific packets.

Further, in this embodiment, all the necessary modifications to the operation of an existing communication apparatus equipped with an LAG function is the modification to the operation for distributing packets to transmitting ports performed in the communication apparatus 100.

Therefore, there is an advantageous effect that as to the communication apparatus 200, an existing communication apparatus equipped with an LAG function can receive packets from the communication apparatus 100 without making any modification thereto.

### (3) Third Embodiment

In the second embodiment, packets to which the identifier B is assigned (i.e., packets that are other than the specific packets and have the predetermined packet length or longer) are not distributed to the specific transmitting port. Therefore, there is a high possibility that the amount of data transmission (the amount of flow) in the specific transmitting port could be relatively small compared to those of the other transmitting ports. Therefore, it is conceivable that the frequency band of the physical link is not effectively used.

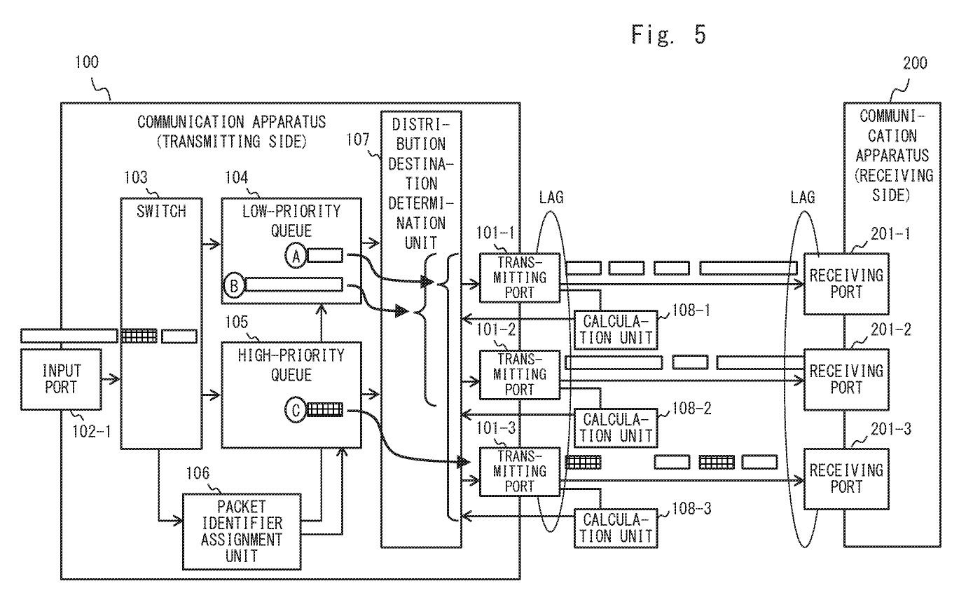

In this embodiment, the frequency band of the physical link is effectively used by adjusting the distribution destination of packets to which the identifier A is assigned (packets that are other than the specific packets and have a packet length shorter than the predetermined packet length) based on the amount of data transmission (hereinafter referred to as a “data transmission amount”) in each of the transmitting ports 101-1 to 101-3. FIG. 5 shows a configuration example of a communication system according to this embodiment. Compared to the second embodiment shown in FIG. 3, the communication system shown in FIG. 5 includes additional calculation units 108-1 to 108-3. The calculation units 108-1 to 108-3 are provided so as to correspond to the transmitting ports 101-1 to 101-3, respectively. Further, each of the calculation units 108-1 to 108-3 calculates the data transmission amount per unit time in the corresponding transmitting port and feeds back the calculated data transmission amount to the distribution destination determination unit 107. The distribution destination determination unit 107 calculates a distribution ratio at the time when packets to which the identifier A is assigned are transmitted from the transmitting ports 101-1 to 101-3 based on the data transmission amount of each of the transmitting ports 101-1 to 101-3. Then, the distribution destination determination unit 107 distributes the packets to which the identifier A is assigned to the transmitting ports 101-1 to 101-3 based on the calculated distribution ratio. For example, the distribution ratio can be determined in such a manner that the smaller the data transmission amount in a transmitting port is, the greater the number of packets to which an identifier A is assigned and which are distributed to that transmitting port becomes.

In this embodiment, the following operations are performed when the distribution destinations for packets to which the identifier A is assigned are adjusted. That is, the calculation units 108-1 to 108-3 calculate data transmission amounts per unit time in the transmitting ports 101-1, 101-2 and 101-3, respectively, and feed back the calculated data transmission amounts to the distribution destination determination unit 107. It is assumed that as a result, the ratio among the data transmission amounts per unit time in the transmitting ports 101-1, 101-2 and 101-3 is 2:2:1 and the data transmission amount in the transmitting port 101-3, which is defined as the specific transmitting port, is smaller as shown in FIG. 5. In this case, for example, the distribution destination determination unit 107 calculates the distribution ratio for the transmitting ports 101-1, 101-2 and 101-3 as 1:1:2, i.e., as a ratio that is in inverse proportion to the ratio of the data transmission amounts. Then, the distribution destination determination unit 107 distributes packets to which the identifier A is assigned to the transmitting ports 101-1, 101-2 and 101-3 in the distribution ratio of 1:1:2.

Note that packets to which the identifier A is assigned may be adjusted at regular intervals.

As described above, in this embodiment, the communication apparatus 100 distributes packets to which the identifier A is assigned to the transmitting ports 101-1 to 101-3 in a distribution ratio that is determined based on the data transmission amount in each of the transmitting ports 101-1 to 101-3, and transmits the packets. Therefore, there is an advantageous effect that the data transmission amount in the specific transmitting port can be prevented from becoming relatively small and hence the frequency band of the physical link can be effectively used. Other advantageous effects are similar to those in the second embodiment.

### (4) Fourth Embodiment

In the second embodiment, specific packets to which the identifier C is assigned are transmitted from the specific transmitting port. However, it is conceivable that a failure may occur in the transmitting port that is defined as the specific transmitting port.

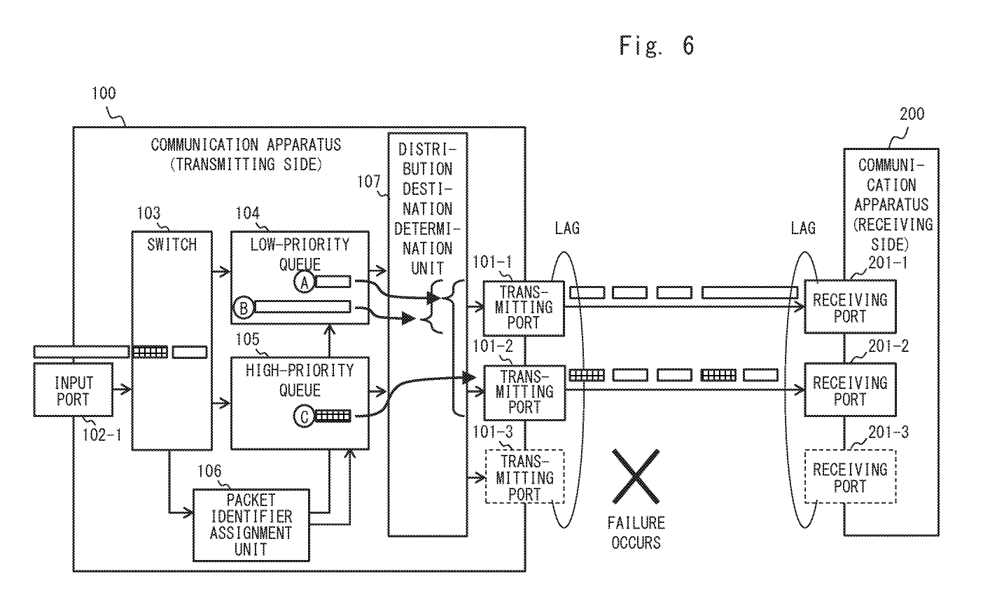

In this embodiment, when a failure occurs in the transmitting port that is defined as the specific transmitting port, a different transmitting port is defined as the specific transmitting port. FIG. 6 shows a configuration example of a communication system according to this embodiment. A configuration itself of the communication system shown in FIG. 6 is similar to that of the second embodiment shown in FIG. 3. However, this embodiment shown in FIG. 6 differs from the second embodiment shown in FIG. 3 in that a priority order is defined among the transmitting ports 101-1 to 101-3 and the distribution destination determination unit 107 includes a function of monitoring a failure occurrence state of the transmitting ports 101-1 to 101-3.

The distribution destination determination unit 107 sets a specific transmitting port based on a failure occurrence state and a priority of each of the transmitting ports 101-1 to 101-3. For example, the distribution destination determination unit 107 can define a transmitting port having the highest priority order among transmitting ports in which no failure has occurred among the transmitting ports 101-1 to 101-3 as a specific transmitting port. In this way, it is ensured that a transmitting port in which no failure has occurred is used as the specific transmitting port to which the distribution destination determination unit 107 distributes specific packets. Further, the distribution destination determination unit 107 determines the distribution destinations of packets to which the identifiers A and B are assigned (i.e., packets other than the specific packets) from among transmitting ports in which no failure has occurred.

In this embodiment, it is assumed that as a priority order among the transmitting ports 101-1 to 101-3: the transmitting port 101-3 has the highest priority; the transmitting port 101-2 has the second highest priority; and the transmitting port 101-1 has the lowest priority. In a situation where no failure occurs in any of the transmitting ports 101-1 to 101-3, the distribution destination determination unit 107 defines the transmitting port 101-3 having the highest priority order as a specific transmitting port. Here, it is assumed that a failure occurs in the transmitting port 101-3, which is defined as the specific transmitting port, as shown in FIG. 6. In this situation, the distribution destination determination unit 107 stops the transmission of packets from the transmitting port 101-3 in which the failure has occurred. Then, the distribution destination determination unit 107 defines the transmitting port 101-2 having the highest priority order between the transmitting ports 101-1 and 101-2, in both of which no failure has occurred, as a specific transmitting port. In this case, the distribution destination determination unit 107 determines the transmitting port 101-2 as the distribution destination of packets to which the identifier C is assigned. Further, the distribution destination determination unit 107 determines the transmitting port 101-1 which is a transmitting port other than the transmitting port 101-2 and in which no failure has occurred as the distribution destination of packets to which the identifier B is assigned. Further, the distribution destination determination unit 107 randomly determines either of the transmitting ports 101-1 and 101-2 in which no failure has occurred as the distribution destination of packets to which the identifier A is assigned. After that, when the failure, which has occurred in the transmitting port 101-3, is solved, the distribution destination determination unit 107 defines the transmitting port 101-3 having the highest priority order as a specific transmitting port again.

Note that the specific transmitting port may be set at regular intervals. Alternatively, the specific transmitting port may be set when a failure occurs in one of the transmitting ports 101-1 to 101-3 or when the failure is solved.

As described above, in this embodiment, the communication apparatus 100 sets a specific transmitting port based on a failure occurrence state and a priority of each of the transmitting ports 101-1 to 101-3. Therefore, when a failure occurs in a transmitting port that is defined as the specific transmitting port, a different transmitting port can be defined as the specific transmitting port. As a result, there is an advantageous effect that the effect of reducing a transmission delay and a delay variation for specific packets can be maintained. Other advantageous effects are similar to those in the second embodiment.

Although the present disclosure has been explained with reference to certain embodiments so far, the present disclosure is not limited to the above-described embodiments. Those skilled in the art can make various modifications to the configuration and details of the present disclosure without departing from the purpose of the present disclosure. For example, although examples in which the number of specific transmitting ports is one are shown in the above-described embodiments, the number of specific transmitting ports is not limited to one. That is, the number of specific transmitting ports may be two or more. Further, although the third and fourth embodiments are separately explained, they may be combined with each other.

Further, the processes in the communication apparatus 100 can be implemented by causing a CPU (Central Processing Unit) to execute a computer program. The program can be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a CD-ROM (Compact Disk-Read Only Memory), a CD-R (CD-Recordable), and a CD-R/W (CD-ReWritable), and a semiconductor memory (such as a mask ROM, a PROM (Programmable ROM), an EPROM (Erasable PROM), a flash ROM, and a RAM (Random Access Memory)). Further, the program can be supplied to computers by using various types of transitory computer readable media. Examples of the transitory computer readable media include an electrical signal, an optical signal, and an electromagnetic wave. The transitory computer readable media can be used to supply programs to computer through a wire communication path such as an electrical wire and an optical fiber, or wireless communication path.

This application is based upon and claims the benefit of priority from Japanese patent applications No. 2015-030445, filed on Feb. 19, 2015, the disclosure of which is incorporated herein in its entirety by reference.

### REFERENCE SIGNS LIST

100 COMMUNICATION APPARATUS
101-1˜101-3 TRANSMITTING PORT
102-1 INPUT PORT
103 SWITCH
104 LOW-PRIORITY QUEUE
105 HIGH-PRIORITY QUEUE
106 PACKET IDENTIFIER ASSIGNMENT UNIT
107 DISTRIBUTION DESTINATION DETERMINATION UNIT
108-1˜108-3 CALCULATION UNIT
200 COMMUNICATION APPARATUS
201-1˜201-3 RECEIVING PORT

1. A communication apparatus comprising:
a plurality of transmitting ports constituting a link aggregation; and
an input port, wherein
the communication apparatus transmits a specific packet input from the input port from a specific transmitting port among the plurality of transmitting ports, and
the communication apparatus transmits a first non-specific packet input from the input port from a transmitting port other than the specific transmitting port among the plurality of transmitting ports, the first non-specific packet being a packet other than the specific packet and having a predetermined packet length or longer.

2. The communication apparatus according to claim 1, wherein the communication apparatus transmits a second non-specific packet input from the input port from the plurality of transmitting ports, the second non-specific packet being a packet other than the specific packet and having a packet length shorter than the predetermined packet length.

3. The communication apparatus according to claim 2, further comprising calculation units provided so as to correspond to the plurality of transmitting ports, respectively, each of the calculation units being configured to calculate an amount of data transmission per unit time in a corresponding transmitting port, wherein
the communication apparatus calculates a distribution ratio at a time when the second non-specific packet is transmitted from the plurality of transmitting ports based on the amount of data transmission in each of the plurality of the transmitting ports, distributes the second non-specific packet to the plurality of transmitting ports based on the distribution ratio, and transmits the second non-specific packet.

4. The communication apparatus according to claim 3, wherein the distribution ratio is determined in such a manner that the smaller the amount of data transmission in a transmitting port is, the greater the number of second non-specific packets transmitted from that transmitting port becomes.

5. The communication apparatus according to claim 2, wherein
a priority is defined in advance for each of the plurality of transmitting ports,
the communication apparatus monitors a failure occurrence state in each of the plurality of transmitting ports, and
the communication apparatus sets the specific transmitting port based on the failure occurrence state and the priority of each of the plurality of transmitting ports.

6. The communication apparatus according to claim 5, wherein the communication apparatus defines a transmitting port having a highest priority among transmitting ports in which no failure has occurred among the plurality of transmitting ports as the specific transmitting port

7. The communication apparatus according to claim 6, wherein
the communication apparatus transmits the first non-specific packet from a transmitting port, the transmitting port being a transmitting port other than the specific transmitting port and in which no failure has occurred among the plurality of transmitting ports, and
the communication apparatus transmits the second non-specific packet from a transmitting port, the transmitting port being a transmitting port in which no failure has occurred among the plurality of transmitting ports.

8. A communication system comprising first and second communication apparatuses connected to each other by a link aggregation, wherein
the first communication apparatus comprises:
a plurality of transmitting ports constituting a link aggregation; and
an input port,
the second communication apparatus comprises a plurality of receiving ports constituting a link aggregation,
the first communication apparatus transmits a specific packet input from the input port from a specific transmitting port among the plurality of transmitting ports, and
the first communication apparatus transmits a first non-specific packet input from the input port from a transmitting port other than the specific transmitting port among the plurality of transmitting ports, the first non-specific packet being a packet other than the specific packet and having a predetermined packet length or longer.

9. The communication system according to claim 8, wherein the first communication apparatus transmits a second non-specific packet input from the input port from the plurality of transmitting ports, the second non-specific packet being a packet other than the specific packet and having a packet length shorter than the predetermined packet length.

10. The communication system according to claim 9, wherein
the first communication apparatus comprises calculation units provided so as to correspond to the plurality of transmitting ports, respectively, each of the calculation units being configured to calculate an amount of data transmission per unit time in a corresponding transmitting port,
the first communication apparatus calculates a distribution ratio at a time when the second non-specific packet is transmitted from the plurality of transmitting ports based on the amount of data transmission in each of the plurality of the transmitting ports, distributes the second non-specific packet to the plurality of transmitting ports based on the distribution ratio, and transmits the second non-specific packet.

11. The communication system according to claim 10, wherein the distribution ratio is determined in such a manner that the smaller the amount of data transmission in a transmitting port is, the greater the number of second non-specific packets transmitted from that transmitting port becomes.

12. The communication system according to claim 9, wherein
a priority is defined in advance for each of the plurality of transmitting ports,
the first communication apparatus monitors a failure occurrence state in each of the plurality of transmitting ports, and
the first communication apparatus sets the specific transmitting port based on the failure occurrence state and the priority of each of the plurality of transmitting ports.

13. The communication system according to claim 12, wherein the first communication apparatus defines a transmitting port having a highest priority among transmitting ports in which no failure has occurred among the plurality of transmitting ports as the specific transmitting port

14. The communication system according to claim 13, wherein
the first communication apparatus transmits the first non-specific packet from a transmitting port, the transmitting port being a transmitting port other than the specific transmitting port and in which no failure has occurred among the plurality of transmitting ports, and
the first communication apparatus transmits the second non-specific packet from a transmitting port, the transmitting port being a transmitting port in which no failure has occurred among the plurality of transmitting ports.

15. A communication method performed by a communication apparatus, the communication apparatus comprising a plurality of transmitting ports constituting a link aggregation, and an input port, the communication method comprising:
transmitting a specific packet input from the input port from a specific transmitting port among the plurality of transmitting ports; and
transmitting a first non-specific packet input from the input port from a transmitting port other than the specific transmitting port among the plurality of transmitting ports, the first non-specific packet being a packet other than the specific packet and having a predetermined packet length or longer.

16. A communication method performed by a communication system comprising first and second communication apparatuses connected to each other by a link aggregation, the first communication apparatus comprising a plurality of transmitting ports constituting a link aggregation, and an input port, the second communication apparatus comprising a plurality of receiving ports constituting a link aggregation, the communication method comprising:
transmitting, by the first communication apparatus, a specific packet input from the input port from a specific transmitting port among the plurality of transmitting ports; and
transmitting, by the first communication apparatus, a first non-specific packet input from the input port from a transmitting port other than the specific transmitting port among the plurality of transmitting ports, the first non-specific packet being a packet other than the specific packet and having a predetermined packet length or longer.
